(19) United States
(12) Patent Application Publication
(10) Pub. No.: US 2026/0204836 A1
(43) Pub. Date: Jul. 16, 2026

(54) CONNECTOR

(71) Applicant: SUMITOMO WIRING SYSTEMS, LTD., Mie (JP)

(72) Inventor: Yutaro OKOCHI, Mie (JP)

(21) Appl. No.: 19/377,432

(22) Filed: Nov. 3, 2025

(30) Foreign Application Priority Data
Nov. 8, 2024 (JP) 2024-195600

(51) Int. Cl. H01R 13/52; H01R 13/74

(52) U.S. Cl. CPC H01R 13/5202; H01R 13/748

(57) ABSTRACT

A connector includes a connector housing including a tubular connector body portion fittable into a mounting hole of a panel along a first direction and a connector flange portion projecting radially outward from an outer periphery of the connector body portion, the connector housing being fixed to the panel, and a packing including a tube portion to be arranged between an outer peripheral surface of the connector body portion and the mounting hole while covering the outer peripheral surface of the connector body portion and an annular flange portion to be arranged between an end surface in the first direction of the connector flange portion and the panel while covering the end surface of the connector flange portion.

### CROSS-REFERENCE TO RELATED APPLICATIONS

This application is based on and claims priority from Japanese Patent Application No. 2024-195600, filed on Nov. 8, 2024, with the Japan Patent Office, the disclosure of which is incorporated herein in its entirety by reference.

### TECHNICAL FIELD

The present invention relates to a connector.

### BACKGROUND

Conventionally, a connector is known which is provided with a connector housing including a tubular connector body portion and a connector flange portion projecting radially outward from the outer periphery of the connector body portion, and a packing to be mounted on the connector housing (see, for example, Japanese Patent Laid-open Publication No. 2022-089567). This packing includes a tube portion to be arranged between the outer peripheral surface of the connector body portion and a mounting hole of a mounting target while covering the outer peripheral surface of the connector body portion and an annular flange portion to be arranged between an end surface of the connector flange portion and the mounting target while covering the end surface of the connector flange portion. The flange portion includes lip portions to be pressed into contact with the mounting target with the connector housing fixed to the mounting target by projecting toward the mounting target. In this configuration, the lip portions are locally pressed into contact with the mounting target, whereby the waterproofness of this part is enhanced. Further, since the flange portion including the lip portions is coupled to the tube portion covering the outer peripheral surface of the connector body portion, the positions in a radial direction of the lip portions are stabilized. Therefore, high waterproofness can be stably provided.

### SUMMARY

However, since the flange portion in the packing of the connector as described above is so shaped that a surface facing the end surface of the connector flange portion extends along the end surface of the connector flange portion, a force for pressing the flange portion into contact with the end surface of the connector flange portion is dispersed without being concentrated. In this way, waterproofness between the flange portion and the connector flange portion may be inferior to that between the lip portions and the mounting target.

The present disclosure aims to provide a connector enabling an improvement in waterproofness.

The present disclosure is directed to a connector with a connector housing including a tubular connector body portion fittable into a mounting hole of a mounting target along a first direction and a connector flange portion projecting radially outward from an outer periphery of the connector body portion, the connector housing being fixed to the mounting target, and a packing including a tube portion to be arranged between an outer peripheral surface of the connector body portion and the mounting hole while covering the outer peripheral surface of the connector body portion and an annular flange portion to be arranged between an end surface in the first direction of the connector flange portion and the mounting target while covering the end surface of the connector flange portion, the flange portion including a first lip portion to be pressed in contact with the mounting target with the connector housing fixed to the mounting target by projecting in the first direction and a second lip portion to be pressed in contact with the connector flange portion with the connector housing fixed to the mounting target by projecting in a first opposite direction opposite to the first direction.

According to the connector of the present disclosure, waterproofness can be improved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector in one embodiment.

FIG. 2 is a partial exploded perspective view of the connector in the embodiment.

FIG. 3 is a section showing a state before the connector in the embodiment is mounted on a panel.

FIG. 4 is a section showing a state where the connector in the embodiment is mounted on the panel.

FIG. 5 is a partial enlarged section of the connector in the embodiment.

FIG. 6 is a partial enlarged section of the connector in the embodiment and the panel.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.
[1] The connector of the present disclosure is provided with a connector housing including a tubular connector body portion fittable into a mounting hole of a mounting target along a first direction and a connector flange portion projecting radially outward from an outer periphery of the connector body portion, the connector housing being fixed to the mounting target, and a packing including a tube portion to be arranged between an outer peripheral surface of the connector body portion and the mounting hole while covering the outer peripheral surface of the connector body portion and an annular flange portion to be arranged between an end surface in the first direction of the connector flange portion and the mounting target while covering the end surface of the connector flange portion, the flange portion including a first lip portion to be pressed in contact with the mounting target with the connector housing fixed to the mounting target by projecting in the first direction and a second lip portion to be pressed in contact with the connector flange portion with the connector housing fixed to the mounting target by projecting in a first opposite direction opposite to the first direction.

According to this configuration, since the flange portion of the packing includes the first lip portion to be pressed in contact with the mounting target with the connector housing fixed to the mounting target by projecting in the first direction, the waterproofness of this part can be enhanced by local press-contact. Further, since the flange portion of the packing includes the second lip portion to be pressed in contact with the connector flange portion with the connector housing fixed to the mounting target by projecting in the first opposite direction, the waterproofness of this part can be enhanced by local press-contact. Therefore, the passage of liquids through the outside and inside of the packing is prevented.
[2] In [1] described above, the first and second lip portions may be constituted by an arc portion formed on an outer edge of the flange portion and having an arcuate cross-sectional shape along a radial direction and exceeding 180°.

According to this configuration, since the first and second lip portions are formed on the outer edge of the flange portion and constituted by the arc portion having an arcuate cross-sectional shape along the radial direction and exceeding 180°, a press-contact force can be kept constant in a circumferential direction of the packing. For example, if the first lip portion has a rectangular cross-sectional shape, the press-contact force may vary in the circumferential direction due to the first lip portion being tilted radially inward in some parts in the circumferential direction of the packing and tilted radially outward in other parts in the circumferential direction. However, this can be avoided. In other words, since the first and second lip portions are constituted by the arc portion having an arcuate cross-sectional shape exceeding 180°, these are not deformed to tilt as in the case where these have a rectangular shape. Thus the press-contact force can be kept constant in the circumferential direction. Therefore, waterproofness can be more enhanced.
[3] In [1] or [2] described above, the tube portion and the flange portion may be coupled by an inclined thick portion having an outer diameter and a thickness gradually increased in the first opposite direction.

According to this configuration, since the tube portion and the flange portion are coupled by the inclined thick portion having the outer diameter and the thickness gradually increased in the first opposite direction, the rigidity of the packing at the inclined thick portion is high. Thus, the assemblability of the packing with the connector housing is improved, for example, as compared to the case where a part coupling the tube portion and the flange portion has a low rigidity. Further, for example, since the inclined thick portion coupling the tube portion and the flange portion has a high rigidity, the positions in the radial direction of the first and second lip portions of the flange portion are stabilized. For example, it is suppressed that the positions in the radial direction of the first and second lip portions move radially outward. Therefore, high waterproofness can be stably provided.
[4] In any one of [1] to [3] described above, the flange portion may include a first recess formed radially inward of the first lip portion and set not to contact the mounting target with the first lip portion pressed in contact with the mounting target and a second recess formed radially inward of the second lip portion and set not to contact the connector flange portion with the second lip portion pressed in contact with the connector flange portion.

According to this configuration, since the flange portion includes the first recess formed radially inward of the first lip portion and set not to contact the mounting target with the first lip portion pressed in contact with the mounting target, a press-contact force of the first lip portion can be maintained high. That is, for example, if the first recess is not formed and a radially inner side of the first lip portion is in contact with the mounting target with the first lip portion pressed in contact with the mounting target, the press-contact force may be dispersed. However, this can be avoided. Further, since the flange portion includes the second recess formed radially inward of the second lip portion and set not to contact the connector flange portion with the second lip portion pressed in contact with the connector flange portion, a press-contact force of the second lip portion can be maintained high. That is, for example, if the second recess is not formed and a radially inner side of the second lip portion is in contact with the connector flange portion with the second lip portion pressed in contact with the connector flange portion, the press-contact force may be dispersed. However, this can be avoided. From these, waterproofness can be more enhanced.
[5] In any one of [1] to [4] described above, the connector housing may include a fixing portion projecting radially outward from an outer periphery of the connector flange portion and including one fixing hole and may be fixed to the mounting target by a bolt passed through the fixing hole.

According to this configuration, since the connector housing includes the fixing portion projecting radially outward from the outer periphery of the connector flange portion and including one fixing hole and is fixed to the mounting target by the bolt passed through the fixing hole, an effect of being able to enhance waterproofness is large. That is, if the connector housing is fixed to the mounting target by the bolt at one fixing hole, i.e. in one location, the entire connector housing tends to be fixed in a state inclined with respect to the mounting target. In this case, waterproofness by the packing tends to be reduced. However, since waterproofness can be enhanced by the first and second lip portions, waterproofness can be, for example, guaranteed.

### Details of Embodiment of Present Disclosure

A specific example of a connector of the present disclosure is described below with reference to the drawings. For the convenience of description, some components may be shown in an exaggerated or simplified manner in each drawing. Further, a dimension ratio of each part may be different in each drawing.

A term “tubular” used in the description of this specification indicates not only a shape formed by a peripheral wall continuous over an entire periphery in a circumferential direction, but also a tubular shape formed by combining a plurality of components and a shape having a cut or the like in a circumferential part such as a C shape. Further, “tubular” outer peripheral shapes include circular shapes, elliptical shapes and polygonal shapes with angular or rounded corners, but there is no limitation to these. A “tubular” shape is a shape including a through hole in a plan view, and an outer peripheral shape and an inner peripheral shape of the through hole may be the same or different. The “tubular” shape may have a predetermined length along an axial direction, in which a center axis passing through a center of the through hole extends, and that length does not matter. Further, a term “annular” used in the description of this specification may indicate an arbitrary structure forming a loop, a continuous shape having no end part and a general loop shaped structure including a gap such as a C shape. “Annular” shapes include circular shapes, elliptical shapes and polygonal shapes with angular or round corners, but there is no limitation to these. Further, terms such as “first”, “second” and “third” in this specification are merely used to distinguish objects and do not rank the objects. The present invention is not limited to these illustrations, but is represented by claims and intended to include all changes in the scope of claims and in the meaning and scope of equivalents.

### Configuration of Connector 10

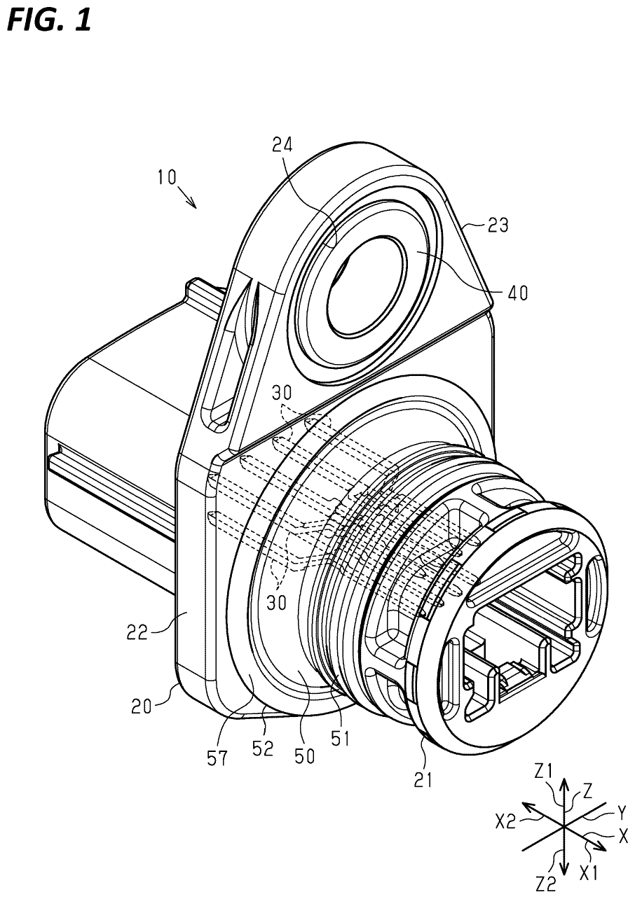

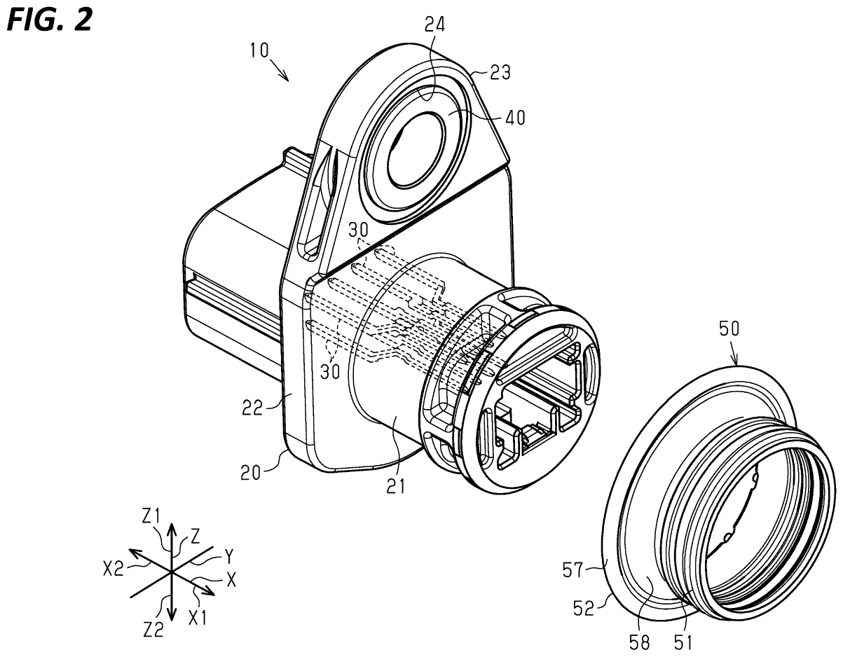

As shown in FIGS. 1 and 2, a connector 10 is provided with a connector housing 20, a plurality of terminals 30, a collar 40 and a packing 50. Note that a first axis X, a second axis Y orthogonal to the first axis X and a third axis Z orthogonal to the first and second axes X, Y are shown in each figure. Further, a first direction X1, which is one direction along the first axis X, and a first opposite direction X2, which is a direction opposite to the first direction X1, are shown in figures. Further, an upward direction Z1, which is one direction along the third axis Z, and a downward direction Z2, which is a direction opposite to the upward direction Z1, are shown in figures.

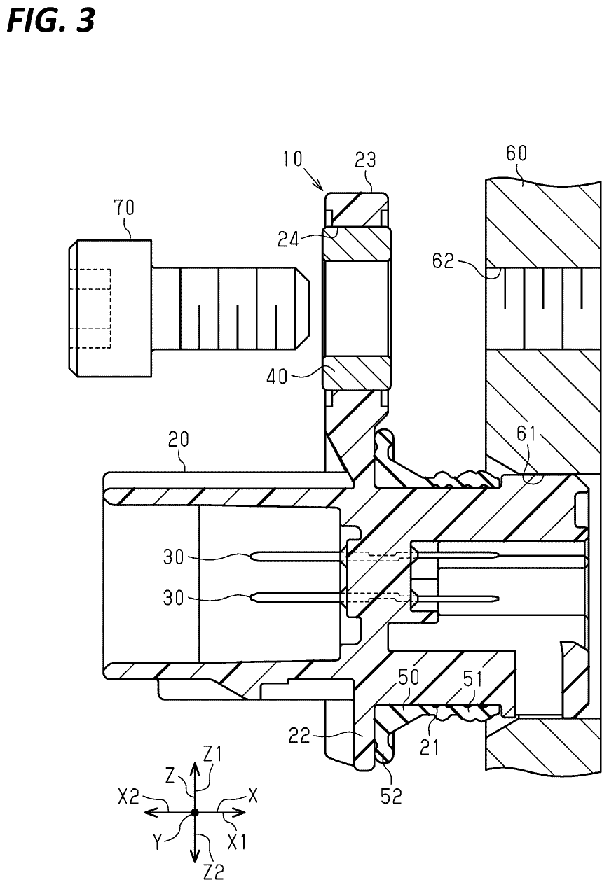

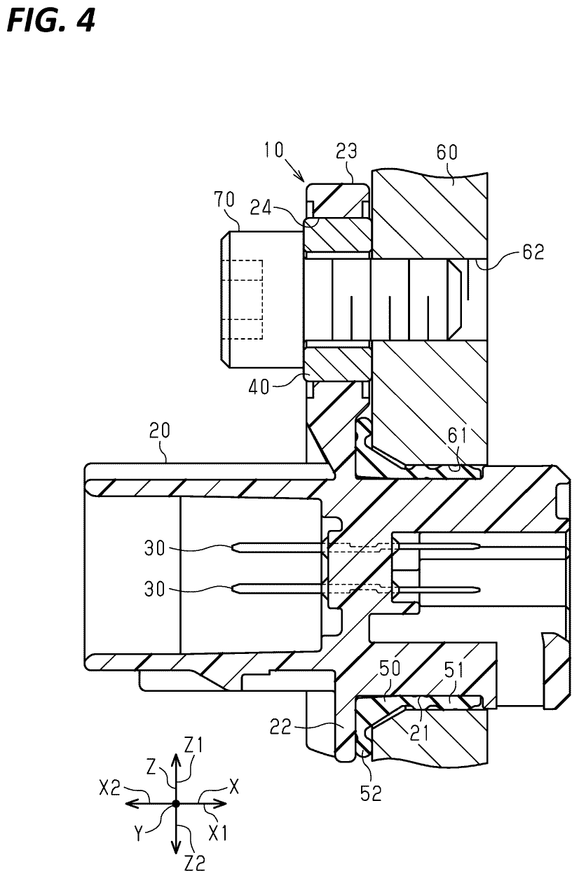

As shown in FIGS. 3 and 4, the connector 10 of this embodiment is, for example, mounted on a panel 60 made of metal and serving as a mounting target in an in-vehicle device provided in a vehicle by a bolt 70. The panel 60 includes a mounting hole 61 penetrating along the first axis X and a bolt hole 62 penetrating along the first axis X.

### Configuration of Connector Housing 20

The connector housing 20 is made of resin.

As shown in FIGS. 1 to 4, the connector housing 20 includes a connector body portion 21, a connector flange portion 22 and a fixing portion 23. The connector body portion 21 is formed into a tubular shape fittable into the mounting hole 61 of the panel 60 (see FIGS. 3 and 4) along the first direction X1. A plurality of the terminals 30 are accommodated and held inside the connector body portion 21.

The connector flange portion 22 is in the form of a plate projecting radially outward from the outer periphery of an intermediate part along the first axis X of the connector body portion 21. The fixing portion 23 is in the form of a plate projecting in the upward direction Z1, which is one radially outward direction, from the outer periphery of the connector flange portion 22. The fixing portion 23 includes one fixing hole 24 penetrating along the first axis X.

As shown in FIGS. 3 and 4, the connector housing 20 is fixed to the panel 60 by the bolt 70 passed through the fixing hole 24. In particular, the collar 40 is fixed to the fixing hole 24. The collar 40 is made of metal. The collar 40 is formed into a tubular shape. The collar 40 is so fixed to the fixing hole 24 that both ends in an axial direction slightly project outward from opening ends of the fixing hole 24.

The connector housing 20 is fixed to the panel 60 by the bolt 70 threadably engaged with the bolt hole 62 of the panel 60 through the collar 40 with an end surface in the first direction X1 of the collar 40 held in contact with the panel 60.

### Configuration of Packing 50

The packing 50 is made of rubber. The packing 50 is mounted on the first direction X1 side of the connector body portion 21.

The packing 50 includes a tube portion 51 to be arranged between the outer peripheral surface of the connector body portion 21 and the mounting hole 61 of the panel 60 while covering the outer peripheral surface of the connector body portion 21 and an annular flange portion 52 to be arranged between an end surface in the first direction X1 of the connector flange portion 22 and the panel 60 while covering the end surface in the first direction X1 of the connector flange portion 22.

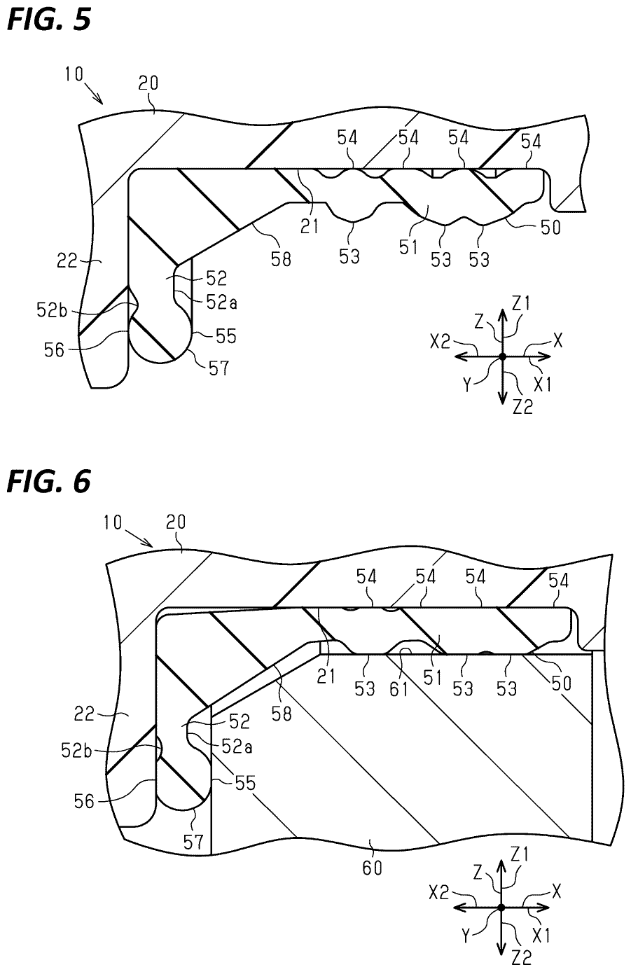

As shown in FIG. 5, the tube portion 51 includes tube portion first lip portions 53 and tube portion second lip portions 54. The tube portion first lip portions 53 project radially outward in a state where the connector housing 20 is not fixed to the panel 60 (see FIGS. 3 and 4). The tube portion second lip portions 54 project radially inward in the state where the connector housing 20 is not fixed to the panel 60. In this embodiment, three tube portion first lip portions 53 are provided at intervals in a direction along the first axis X, which is an axis of the tube portion 51. Further, in this embodiment, four tube portion second lip portions 54 are provided at intervals in the direction along the first axis X. Further, three tube portion second lip portions 54 in the first direction X1 and two tube portion first lip portions 53 in the first direction X1 are alternately arranged in the first opposite direction X2 from an end part in the first direction X1 of the tube portion 51. Further, one tube portion first lip portion 53 in the first opposite direction X2 and one tube portion second lip portion 54 in the first opposite direction X2 are arranged at the same position in the direction along the first axis X.

As shown in FIG. 6, the tube portion first lip portions 53 are pressed in contact with the inner peripheral surface of the mounting hole 61 of the panel 60 with the connector housing 20 fixed to the panel 60. Further, the tube portion second lip portions 54 are pressed in contact with the outer peripheral surface of the connector body portion 21 with the connector housing 20 fixed to the panel 60. Note that the three tube portion second lip portions 54 in the first direction X1 of this embodiment are pressed in contact with the outer peripheral surface of the connector body portion 21 to eliminate boundaries, in other words, eliminate gaps between the tube portion second lip portions 54 while being pressed in contact with the outer peripheral surface of the connector body portion 21.

As shown in FIG. 5, the flange portion 52 includes a first lip portion 55 and a second lip portion 56. The first lip portion 55 projects in the first direction X1 in the state where the connector housing 20 is not fixed to the panel 60 (see FIGS. 3 and 4). The first lip portion 55 projects in the first direction X1 with respect to a part radially inward of the first lip portion 55. The second lip portion 56 projects in the first opposite direction X2 in the state where the connector housing 20 is not fixed to the panel 60. The second lip portion 56 projects in the first opposite direction X2 with respect to a part radially inward of the second lip portion 56. The first and second lip portions 55, 56 are arranged at the same position in a radial direction of the flange portion 52. In this way, the first and second lip portions 55, 56 constitute one lip portion in combination. The first and second lip portions 55, 56 are formed on the outer edge of the flange portion 52. The first and second lip portions 55, 56 are constituted by an arc portion 57 having a cross-sectional shape along the radial direction and exceeding 180° in the state where the connector housing 20 is not fixed to the panel 60. That is, the first lip portion 55 is a part projecting in the first direction X1 in the arc portion 57, and the second lip portion 56 is a part projecting in the first opposite direction X2 in the arc portion 57.

As shown in FIG. 6, the first lip portion 55 is pressed in contact with the panel 60 with the connector housing 20 fixed to the panel 60. Further, the second lip portion 56 is pressed in contact with the connector flange portion 22 with the connector housing 20 fixed to the panel 60. That is, the arc portion 57 is sandwiched between the panel 60 and the connector flange portion 22 with the connector housing 20 fixed to the panel 60. In this way, the first lip portion 55 is pressed in contact with the panel 60, and the second lip portion 56 is pressed in contact with the connector flange portion 22. In other words, one lip portion formed by combining the first and second lip portions 55, 56 of the flange portion 52 has surfaces to be pressed into contact with the panel 60 and the connector flange portion 22.

Further, the flange portion 52 includes a first recess 52a. The first recess 52a is formed radially inward of the first lip portion 55 and set not to contact the panel 60 with the first lip portion 55 pressed in contact with the panel 60. In other words, a projecting amount of the first lip portion 55 in the first direction X1 is so set that a radially inner side of the first lip portion 55 does not contact the panel 60 even in a state pressed in contact with the panel 60.

The flange portion 52 includes a second recess 52b. The second recess 52b is formed radially inward of the second lip portion 56 and set not to contact the connector flange portion 22 with the second lip portion 56 pressed in contact with the connector flange portion 22. In other words, a projecting amount of the second lip portion 56 in the first opposite direction X2 is so set that a radially inner side of the second lip portion 56 does not contact the connector flange portion 22 even in a state pressed in contact with the connector flange portion 22.

Further, the tube portion 51 and the flange portion 52 are coupled by an inclined thick portion 58 having an outer diameter and a thickness gradually increased in the first opposite direction X2. That is, a part connecting the tube portion 51 and the flange portion 52 serves as the inclined thick portion 58 having a triangular cross-sectional shape along the radial direction by having the outer diameter gradually increased in the first opposite direction X2. Note that the flange portion 52 of this embodiment is an entire part extending radially outward of the inclined thick portion 58.

### Functions of Connector 20

As shown in FIG. 4, the connector 10 configured as described above is fixed to the panel 60 by the bolt 70 threadably engaged with the bolt hole 62 of the panel 60 through the collar 40 with the connector body portion 21 fit in the mounting hole 61 of the panel 60.

Then, the tube portion 51 of the packing 50 is arranged between the outer peripheral surface of the connector body portion 21 and the mounting hole 61 of the panel 60. Further, the flange portion 52 of the packing 50 is arranged between the end surface in the first direction X1 of the connector flange portion 22 and the panel 60.

As shown in FIG. 6, the tube portion first lip portions 53 are pressed in contact with the inner peripheral surface of the mounting hole 61 of the panel 60. Further, the tube portion second lip portions 54 are pressed in contact with the outer peripheral surface of the connector body portion 21. Further, the first lip portion 55 is pressed in contact with the panel 60. Further, the second lip portion 56 is pressed in contact with the connector flange portion 22. Therefore, the passage of liquids including salt water through the outside and inside of the packing 50 is prevented.

### Effects of Embodiment

Next, effects of this embodiment are described.
(1) Since the flange portion 52 of the packing 50 includes the first lip portion 55 to be pressed in contact with the panel 60 with the connector housing 20 fixed to the panel 60 by projecting in the first direction X1, the waterproofness of this part can be enhanced by local press-contact. Further, since the flange portion 52 includes the second lip portion 56 to be pressed in contact with the connector flange portion 22 with the connector housing 20 fixed to the panel 60 by projecting in the first opposite direction X2, the waterproofness of this part can be enhanced by local press-contact. Therefore, the passage of liquids through the outside and inside of the packing 50 is prevented.
(2) Since the first and second lip portions 55, 56 are formed on the outer edge of the flange portion 52 and constituted by the arc portion 57 having an arcuate cross-sectional shape along the radial direction and exceeding 180°, the press-contact force can be kept constant in a circumferential direction of the packing 50. For example, if the first lip portion 55 has a rectangular cross-sectional shape, the press-contact force may vary in the circumferential direction due to the first lip portion 55 being tilted radially inward in some parts in the circumferential direction of the packing 50 and tilted radially outward in other parts in the circumferential direction. However, this can be avoided. In other words, since the first and second lip portions 55, 56 are constituted by the arc portion 57 having an arcuate cross-sectional shape exceeding 180°, these are not deformed to tilt as in the case where these have a rectangular shape. Thus the press-contact force can be kept constant in the circumferential direction. Therefore, waterproofness can be more enhanced.
(3) Since the tube portion 51 and the flange portion 52 are coupled by the inclined thick portion 58 having the outer diameter and the thickness gradually increased in the first opposite direction X2, the rigidity of the packing 50 at the inclined thick portion 58 is high. Thus, the assemblability of the packing 50 with the connector housing 20 is improved, for example, as compared to the case where a part coupling the tube portion 51 and the flange portion 52 has a low rigidity. Further, for example, since the inclined thick portion 58 coupling the tube portion 51 and the flange portion 52 has a high rigidity, the positions in the radial direction of the first and second lip portions 55, 56 of the flange portion 52 are stabilized. For example, it is suppressed that the positions in the radial direction of the first and second lip portions 55, 56 move radially outward. Therefore, high waterproofness can be stably provided.
(4) The flange portion 52 includes the first recess 52a formed radially inward of the first lip portion 55 and set not to contact the panel 60 with the first lip portion 55 pressed in contact with the panel 60. Thus, the press-contact force of the first lip portion 55 can be maintained high. That is, for example, if the first recess 52a is not formed and the radially inner side of the first lip portion 55 is in contact with the panel 60 with the first lip portion 55 pressed in contact with the panel 60, the press-contact force may be dispersed. However, this can be avoided. Further, the flange portion 52 includes the second recess 52b formed radially inward of the second lip portion 56 and set not to contact the connector flange portion 22 with the second lip portion 56 pressed in contact with the connector flange portion 22. Thus, the press-contact force of the second lip portion 56 can be maintained high. That is, for example, if the second recess 52b is not formed and the radially outer side of the second lip portion 56 is in contact with the connector flange portion 22 with the second lip portion 56 pressed in contact with the connector flange portion 22, the press-contact force may be dispersed. However, this can be avoided. From these, waterproofness can be more enhanced.
(5) The connector housing 20 includes the fixing portion 23 projecting radially outward from the outer periphery of the connector flange portion 22 and including one fixing hole 24 and is fixed to the panel 60 by the bolt 70 passed through the fixing hole 24. Thus, an effect of being able to enhance waterproofness is large. That is, if the connector housing 20 is fixed to the panel 60 by the bolt 70 at one fixing hole 24, i.e. in one location, the entire connector housing 20 tends to be fixed in a state inclined with respect to the panel 60. In this case, waterproofness by the packing 50 tends to be reduced. However, since waterproofness can be enhanced by the first and second lip portions 55, 56, waterproofness can be, for example, guaranteed.

### Modifications

The above embodiment can be modified and carried out as follows. The above embodiment and the following modifications can be combined with each other and carried out without technically contradicting.
Although the first and second lip portions 55, 56 are constituted by parts of the arc portion 57 having an arcuate cross-sectional shape exceeding 180° in the above embodiment, there is no limitation to this. For example, each of the first and second lip portions may have a rectangular shape, a triangular shape or one of those shapes with rounded corners.
Although the tube portion 51 and the flange portion 52 are coupled by the inclined thick portion 58 having the outer diameter and the thickness gradually increased in the first opposite direction X2 in the above embodiment, there is no limitation to this. For example, the tube portion 51 and the flange portion 52 may be coupled by a part having a constant thickness.
Although the flange portion 52 includes the first recess 52a formed radially inward of the first lip portion 55 and set not to contact the panel 60 with the first lip portion 55 pressed in contact with the panel 60 in the above embodiment, there is no limitation to this. That is, with the first lip portion 55 pressed in contact with the panel 60, the first lip portion 55 may be squeezed, whereby the part radially inward of the first lip portion 55 and corresponding to the first recess 52a may be in contact with the panel 60 without any gap.

Further, although the flange portion 52 includes the second recess 52b formed radially inward of the second lip portion 56 and set not to contact the connector flange portion 22 with the second lip portion 56 pressed in contact with the connector flange portion 22, there is no limitation to this. That is, with the second lip portion 56 pressed in contact with the connector flange portion 22, the radially inner side of the second lip portion 56 may be in contact with the connector flange portion 22 without any gap.
Although the connector housing 20 includes the fixing portion 23 projecting radially outward from the outer periphery of the connector flange portion 22 and including one fixing hole 24 in the above embodiment, there is no limitation to this. For example, two or more fixing holes 24 may be provided. Note that, of course, the connector 10 may include two or more collars 40 if two or more fixing holes 24 are provided.
Although the tube portion 51 includes three tube portion first lip portions 53 in the above embodiment, there is no limitation to this and a different number of the tube portion first lip portions 53 may be provided. Further, the tube portion 51 includes four tube portion second lip portions 54, there is no limitation to this and a different number of the tube portion second lip portions 54 may be provided. Further, a positional relationship of the tube portion first lip portions 53 and the tube portion second lip portions 54 of the above embodiment may be different.
Although the bolt 70 mounts the connector 10 on the panel 60 by being threadably engaged with the bolt hole 62 formed in the panel 60 through the collar 40 in the above embodiment, there is no limitation to this. For example, the bolt 70 may mount the connector 10 on the panel 60 by being threadably engaged with a nut through a hole formed in the panel 60 and the collar 40.
Although the mounting target is the panel 60 made of metal in the in-vehicle device in the above embodiment, there is no limitation to this and the mounting target may be different.
The embodiment disclosed this time is illustrative in all aspects, and the present invention is not limited to these illustrations. That is, the scope of the present invention is represented by claims and intended to include all changes in the scope of claims and in the meaning and scope of equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a connector housing including a tubular connector body portion fittable into a mounting hole of a mounting target along a first direction and a connector flange portion projecting radially outward from an outer periphery of the connector body portion, the connector housing being fixed to the mounting target; and
a packing including a tube portion to be arranged between an outer peripheral surface of the connector body portion and the mounting hole while covering the outer peripheral surface of the connector body portion and an annular flange portion to be arranged between an end surface in the first direction of the connector flange portion and the mounting target while covering the end surface of the connector flange portion,
the flange portion including a first lip portion to be pressed in contact with the mounting target with the connector housing fixed to the mounting target by projecting in the first direction and a second lip portion to be pressed in contact with the connector flange portion with the connector housing fixed to the mounting target by projecting in a first opposite direction opposite to the first direction.

2. The connector of claim 1, wherein the first and second lip portions are constituted by an arc portion formed on an outer edge of the flange portion and having an arcuate cross-sectional shape along a radial direction and exceeding 180°.

3. The connector of claim 1, wherein the tube portion and the flange portion are coupled by an inclined thick portion having an outer diameter and a thickness gradually increased in the first opposite direction.

4. The connector of claim 1, wherein the flange portion includes a first recess formed radially inward of the first lip portion and set not to contact the mounting target with the first lip portion pressed in contact with the mounting target and a second recess formed radially inward of the second lip portion and set not to contact the connector flange portion with the second lip portion pressed in contact with the connector flange portion.

5. The connector of claim 1, wherein the connector housing includes a fixing portion projecting radially outward from an outer periphery of the connector flange portion and including one fixing hole and is fixed to the mounting target by a bolt passed through the fixing hole.
